(19) United States
(12) Patent Application Publication
(10) Pub. No.: US 2011/0001861 A1
(43) Pub. Date: Jan. 6, 2011

(54) SOLID-STATE IMAGING DEVICE

(76) Inventors: Nagataka TANAKA, Yokohama-shi (JP); Makoto Monoi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/828,718

(22) Filed: Jul. 1, 2010

(30) Foreign Application Priority Data
Jul. 2, 2009 (JP) 2009-157955

(51) Int. Cl. H04N 5/335

(52) U.S. Cl. 348/300; 348/E05.091

(57) ABSTRACT

According to one embodiment, a solid-state imaging device includes an imaging region, and a control circuit. In a first operation mode, the control circuit performs control in which signal charges of first and second photodiodes are transmitted to a floating diffusion. In a second operation mode, the control circuit performs control in which a signal charge of the second photodiode is transmitted to the floating diffusion.

### CROSS-REFERENCE TO RELATED APPLICATIONS

This application is based upon and claims the benefit of priority from Japanese Patent Application No. 2009-157955, filed Jul. 2, 2009; the entire contents of which are incorporated herein by reference.

### FIELD

Embodiments described herein relate generally to a solid-state imaging device such as a CMOS image sensor, in which two photodiodes are arranged in a unit cell.

### BACKGROUND

Pluralities of unit pixels (unit cells) are arranged in rows and columns in an imaging region of a CMOS image sensor. Generally, one photodiode is disposed as a photoelectric transducer in each unit cell. Specifically, each unit cell includes a photodiode, a reading transistor which reads a stored charge of the photodiode to a floating diffusion, an amplifying transistor which amplifies a signal potential of the floating diffusion and outputs an amplified potential, a reset transistor which resets a gate potential of the amplifying transistor, and an address transistor.

The operation of the CMOS image sensor is generally controlled as described below. Each unit cell temporarily stores a signal charge generated in accordance with the intensity of incident light in its photodiode. When the time of reading out the signal of the photodiode comes, the potential of the floating diffusion is reset, and then the signal charge stored in the photodiode is transmitted to the floating diffusion. The amplifying transistor forms a source follower circuit together with a current source placed outside the imaging region, and a voltage of a level according to a signal charge quantity of the floating diffusion is output from the source follower circuit.

In CMOS image sensors having the above unit cells, the dynamic range of each unit cell depends on a saturation level of the floating diffusion or the photodiode thereof, and output thereof is saturated when incident light of a level larger than the saturation level enters.

United States Patent Application Publication No. US 2005/0212939 (Oda et al.) and U.S. Pat. No. 6,831,692 (Oda) both disclose a CCD area sensor, in which a photodiode of high sensitivity and a photodiode of low sensitivity are arranged adjacent to each other in each unit cell.

### BRIEF DESCRIPTION OF THE DRAWINGS

FIG. 1 is a block diagram of a CMOS image sensor according to a first embodiment;

FIG. 2A is a pattern plan view of a part of an imaging region of the CMOS image sensor of FIG. 1, schematically illustrating a part of a layout image of device formation regions and gates together with various signal lines;

FIG. 2B is a pattern plan view schematically illustrating a layout image of color filters and microlenses of the CMOS image sensor of FIG. 1;

FIG. 3 is a diagram illustrating an example of operation timing of a low-sensitivity mode suitable for the case where signal charge quantities stored in the photodiodes of each unit cell in FIG. 1 are large, a potential in a semiconductor substrate in reset operation, and a potential in a reading operation;

FIG. 4 is a diagram illustrating an example of operation timing of a high-sensitivity mode suitable for the case where signal charge quantities stored in the photodiodes of each unit cell in FIG. 1 are small, a potential in a semiconductor substrate in a reset operation, and a potential in a reading operation;

FIG. 5 is a characteristic diagram of the CMOS image sensor of the first embodiment;

FIG. 6 is a pattern plan view schematically illustrating a part of a layout image of device formation regions and gates of an imaging region of a CMOS image sensor according to a second embodiment;

FIG. 7 is a pattern plan view of one of unit cells in an imaging region of a CMOS image sensor according to a third embodiment, schematically illustrating a layout image of device formation regions, gates, color filters and microlenses of the CMOS image sensor; and

FIG. 8 is a block diagram of a CMOS image sensor according to a fourth embodiment.

### DETAILED DESCRIPTION

In general, according to one embodiment, a solid-state imaging device includes an imaging region, and a control circuit. In the imaging region, a plurality of unit cells are arranged in rows and columns, and each unit cell includes first and second photodiodes, first and second reading transistors, a reset transistor, and an amplifying transistor. The control circuit has a first operation mode and a second operation mode. In the first operation mode, the control circuit performs control in which signal charges of the first and second photodiodes are transmitted to a floating diffusion through the first and second reading transistors and summed up, a potential of the floating diffusion is amplified by the amplifying transistor, and a signal is output. In the second operation mode, the control circuit performs control in which a signal charge of the second photodiode is transmitted to the floating diffusion through the second reading transistor, a potential of the floating diffusion is amplified by the amplifying transistor, and a signal is output.

The following is an explanation of various embodiments, with reference to the drawings. In the explanation, constituent elements common to all the drawings are denoted by respective common reference numerals.

### First Embodiment

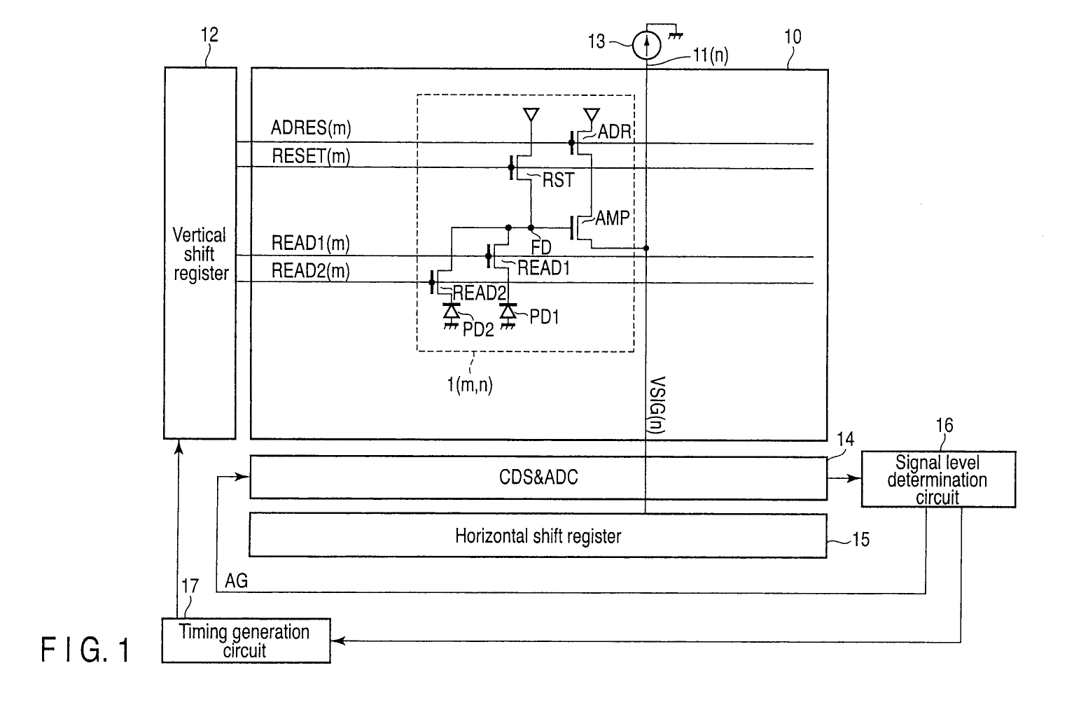

FIG. 1 is a block diagram of a CMOS image sensor according to a first embodiment. The CMOS image sensor has an imaging region 10. The imaging region 10 includes a plurality of unit cells 1(m, n) arranged in m rows and n columns. FIG. 1 illustrates one unit cell 1(m, n) located in row m and column n among the unit cells, and a vertical signal line 11(n), among a plurality of vertical signal lines arranged in the column direction in accordance with respective columns (unit cell columns) of the imaging region.

At one end (the left side in FIG. 1) of the imaging region 10, a vertical shift register 12 is provided. The vertical shift register 12 supplies pixel driving signals, such as ADRES(m), RESET(m), READ1(m), and READ2(m), to each row of the imaging region.

Current sources 13 connected to vertical signal lines 11(n) of respective columns are disposed on the upper end side (the upper side in FIG. 1) of the imaging region 10. These current sources 13 form respective source follower circuits, together with amplifying transistors in the unit cells of the respective columns.

On the lower end side (the lower side in FIG. 1) of the imaging region, a CDS and ADC 14, which includes a correlated double sampling (CDS) circuit and an analog to digital converter (ADC) circuit, and a horizontal shift register 15 are arranged. The CDS and ADC 14 and the horizontal shift register 15 are connected to the vertical signal lines 11(n) of the columns. The CDS and ADC 14 executes CDS processing for an analog signal output from each unit cell, and converts the signal into a digital signal.

A signal level determination circuit 16 determines whether an output voltage VSIG(n) of the unit cell is smaller or larger than a predetermined value on the basis of a level of an output signal digitalized by the CDS and ADC 14, supplies a determination output to a timing generation circuit 17, and supplies the determination output to the CDS and ADC 14 as a control signal AG for setting an analog gain.

The timing generation circuit 17 generates an electronic shutter control signal for controlling an accumulation time of the photodiodes, and a control signal for switching the operation modes, at predetermined timings, and supplies the signals to the vertical shift register 12.

The unit cells 1 have the same circuit configuration. In the first embodiment, a photodiode of high sensitivity and a photodiode of low sensitivity are arranged in each unit cell. The following is an explanation of the configuration of unit cell 1(m, n) illustrated in FIG. 1.

The unit cell 1(m, n) includes a first photodiode PD1 which performs photoelectric conversion for incident light and stores a converted signal charge, a first reading transistor READ1 which is connected to the first photodiode PD1 and reads the signal charge of the first photodiode PD1; a second photodiode PD2 which has a light sensitivity lower than that of the first photodiode PD1, and performs photoelectric conversion for incident light and stores a converted signal charge; a second reading transistor READ2 which is connected to the second photodiode PD2 and reads the signal charge of the second photodiode PD2; a floating diffusion PD which is connected to one of ends of the first and the second reading transistors READ1 and READ2, and temporarily stores the signal charges read by the first and the second reading transistors READ1 and READ2; an amplifying transistor AMP which has a gate electrode connected to the floating diffusion FD and amplifies a signal of the floating diffusion FD and outputs the signal to the vertical signal line 11(n); a reset transistor RST which has a drain connected to a power supply node in the cell, has a source connected to the floating diffusion FD, and resets a potential of the floating diffusion FD to a power supply potential; and an address transistor ADR which has a drain connected to a power supply node in the cell, has a source connected to a drain of the amplifying transistor AMP, and selects a unit cell of a desired horizontal position in the vertical direction. Specifically, the address transistor ADR is connected to the amplifying transistor AMP in series. In this embodiment, all the above transistors are n-channel MOSFETs.

Gate electrodes of the address transistor ADR, the reset transistor RST, the first reading transistor READ1, and the second reading transistor READ2 are controlled by pixel driving signals ADRES(m), RESET(m), READ1(m), and READ2(m), respectively, of the corresponding row. These pixel driving signals ADRES(m), RESET(m), READ1(m), and READ2(m) are output from the vertical shift register 12. In addition, the source of the amplifying transistor AMP is connected to the vertical signal line 11(n) of the corresponding column.

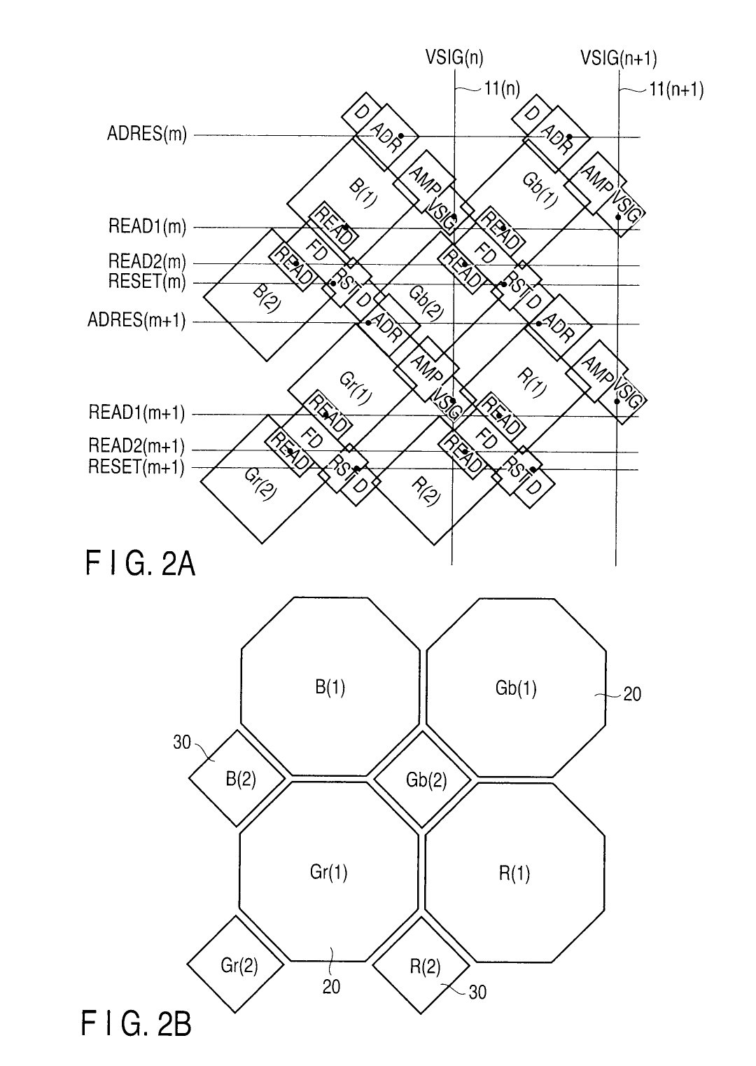

FIG. 2A is a pattern plan view of a part of the imaging region of the CMOS image sensor of FIG. 1, schematically illustrating a layout image of device formation regions and gates. FIG. 2B is a pattern plan view of a part of the imaging region of the CMOS image sensor of FIG. 1, schematically illustrating a layout image of color filters and microlenses of the CMOS image sensor of FIG. 1. A usual RGB bayer arrangement is adopted for the arrangement of color filters and microlenses.

In FIGS. 2A and 2B, reference numerals R(1) and R(2) denote regions corresponding to photodiodes, or color filters and microlenses for R, B(1) and B(2) denote regions corresponding to photodiodes, or color filters and microlenses for B, and Gb(1), Gb(2), Gr(1) and Gr(2) denote regions corresponding to photodiodes, or color filters and microlenses for G. Reference numeral D denotes a drain region. In addition, to clarify the correspondence between the regions and various signal lines, FIGS. 2A and 2B also illustrate signal lines which transmit respective pixel driving signals ADRES(m), RESET(m), READ1(m), and READ2(m) of row m, signal lines which transmit respective pixel driving signals ADRES(m+1), RESET(m+1), READ1(m+1), and READ2(m+1) of row (m+1), a vertical signal line 11(n) of column n, and a vertical signal line 11(n+1) of column (n+1).

As illustrated in FIGS. 2A and 2B, a photodiode of high sensitivity and a photodiode of low sensitivity are arranged in each unit cell, a color filter and microlens 20 having a large area are arranged on the photodiode of high sensitivity, and a color filter and microlens 30 having a small area are arranged on the photodiode of low sensitivity.

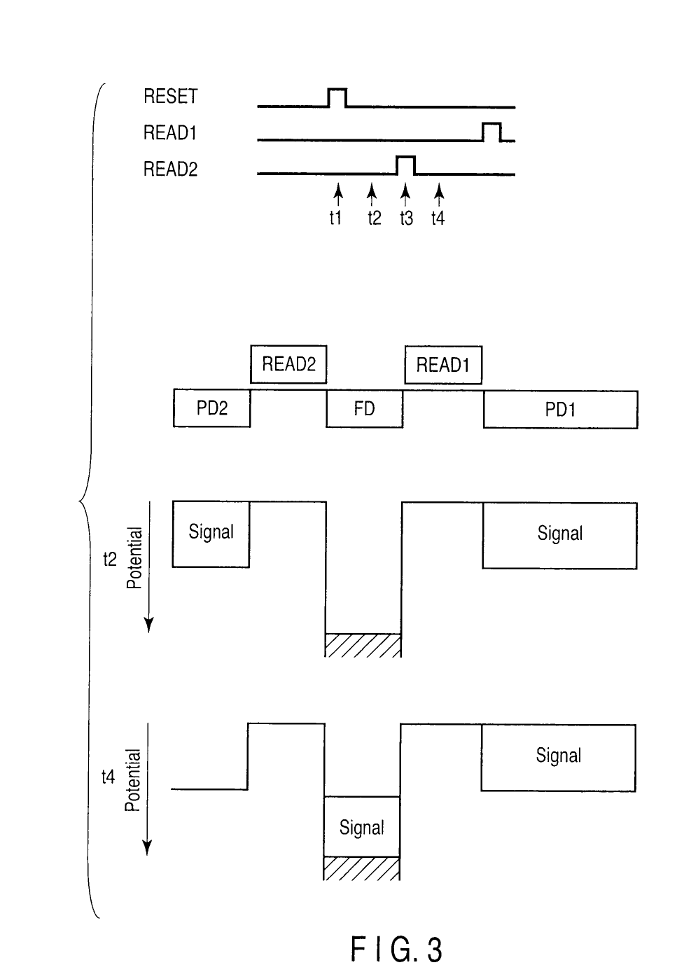

FIG. 3 illustrates an example of operation timing of a low sensitivity mode suitable for the case where signal charge quantities stored in the first and the second photodiodes of each unit cell are large (when it is light) in the CMOS image sensor of FIG. 1, a potential in a semiconductor substrate in a reset operation, and a potential in a reading operation. When the signal charge quantities are large, it is required to lower the sensitivity of the sensor, to prevent saturation of the sensor as much as possible and increase the dynamic range.

First, at time t1, the reset transistor RST is turned on, and thereby reset operation is performed. At time t2 after the reset operation is performed, a potential of the floating diffusion FD is set to the same potential level as that of the drain (power supply node in the cell). After the reset operation is finished, the reset transistor RST is turned off. Thereafter, a voltage according to the potential of the floating diffusion FD is output to the vertical signal line 11. This voltage value is taken into the CDS circuit of the CDS and ADC 14 (dark-time level).

Next, the second reading transistor READ2 is turned on, and a signal charge stored in the photodiode PD2 up to that time is transmitted to the floating diffusion FD. In the low sensitivity mode, at time t3, a reading operation is performed in which only the second reading transistor READ2 is turned on, and only a signal charge stored in the second photodiode PD2 having the lower sensitivity is transmitted to the floating diffusion PD. At time t4 after the reading operation is performed, the potential of the floating diffusion FD changes together with transmission of the signal charge. A voltage according to the change in potential of the floating diffusion PD is output to the vertical signal line 11, and this voltage value is taken into the CDS circuit (signal level). Thereafter, the dark-time level is subtracted from the signal level in the CDS circuit, thereby noise caused by fluctuations in threshold voltage (Vth) of the amplifying transistor AMP is cancelled, and only a pure signal component is taken out (CDS operation).

In the low sensitivity mode, explanation of operations of the first photodiode PD1 and the first reading transistor READ1 is omitted to simplify the explanation. Actually, to prevent a signal charge of the first photodiode PD1 from overflowing onto the floating diffusion FD, it is desirable to turn on the first reading transistor READ1 directly before a reset operation of the floating diffusion FD is performed, and discharge the signal charge stored in the first photodiode PD1. In addition, the first reading transistor READ1 may always be turned on, except for the period of performing reset operation of the floating diffusion FD and operation of reading a signal from the second photodiode PD2.

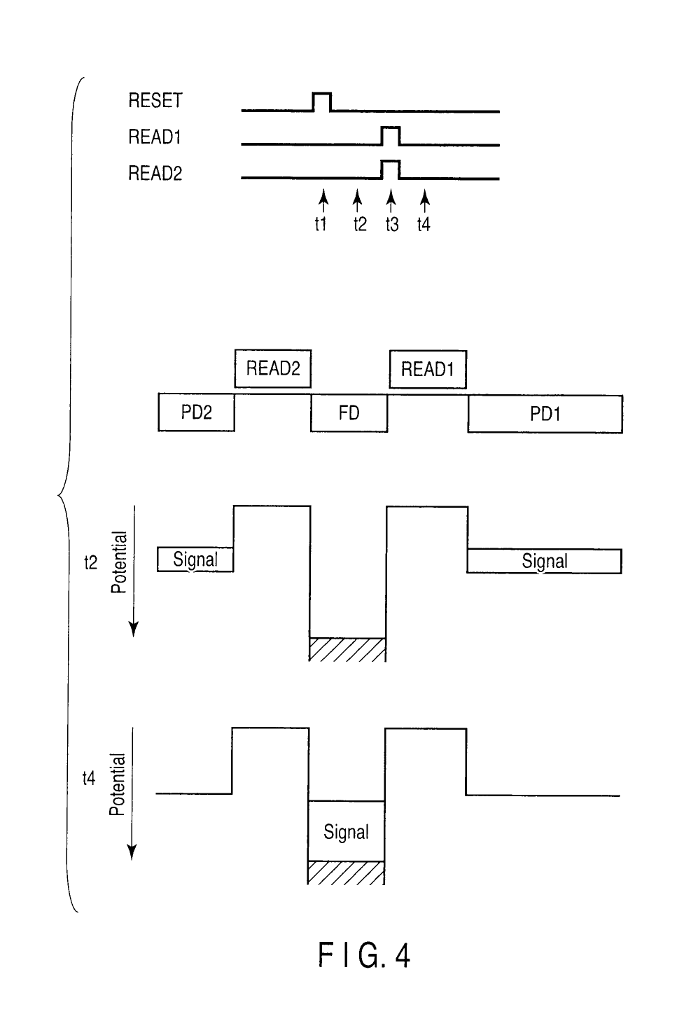

On the other hand, FIG. 4 illustrates an example of operation timing of a high sensitivity mode suitable for the case where signal charge quantities stored in the first and the second photodiodes of each unit cell are small in the CMOS image sensor of FIG. 1, a potential in a semiconductor substrate in reset operation, and a potential in reading operation. When the signal charge quantities are small, it is required to increase the sensitivity of the CMOS image sensor and improve the S/N ratio.

First, at time t1, the reset transistor RST is turned on and a reset operation is performed. At time t2 after the reset operation is performed, a potential of the floating diffusion FD is set to the same potential level as that of the drain (power supply node in the cell). After the reset operation is finished, the reset transistor RST is turned off. Thereafter, a voltage according to the potential of the floating diffusion FD is output to the vertical signal line 11. This voltage value is taken into the CDS circuit of the CDS and ADC 14 (dark-time level).

Next, at time t3, both the first and the second reading transistors READ1 and READ2 are turned on, and signal charges stored in the first and the second photodiodes PD1 and PD2 up to that time are transmitted to the floating diffusion FD. In the high sensitivity mode, a reading operation is performed in which both the first and the second reading transistors READ1 and READ2 are turned on, and all the signal charges of the first and the second photodiodes PD1 and PD2 obtained in a dark state are transmitted to the floating diffusion FD and summed up. At time t4 after the reading operation is performed, the potential of the floating diffusion FD changes together with transmission of the signal charges. A voltage according to the change in potential of the floating diffusion FD is output to the vertical signal line 11, and this voltage value is taken into the CDS circuit (signal level). Thereafter, the dark-time level is subtracted from the signal level in the CDS circuit, thereby noise is cancelled in the same manner as in the low sensitivity mode, and only a pure signal component is taken out (CDS operation).

Generally, in CMOS image sensors, thermal noise and 1/f noise generated in the amplifying transistor AMP account for a large proportion of the total noise generated. Therefore, it is advantageous for improving the S/N ratio to sum up signals and increase the signal level at a step of transmitting the signals to the floating diffusion FD, before noise is generated, like the CMOS image sensor of the present embodiment. In addition, the number of pixels is reduced by summing up signals at a step of transmitting the signals to the floating diffusion FD, that is, signals of two pixels are summed up and read as one pixel. This produces the effect that the frame rate of the CMOS image sensor can easily be improved.

The present embodiment is not limited to the case where signal charges are summed up in the floating diffusion FD. It is possible to transmit signal charges of the first and the second photodiodes PD1 and PD2 to the floating diffusion FD independently of each other through the first and the second reading transistors READ1 and READ2, respectively, amplify the potentials of the floating diffusion FD by the amplifying transistor AMP to output voltage signals independently of each other, and sum up the voltage signals in a signal processing circuit outside the CMOS sensor. In this case, the signal processing circuit outside the CMOS sensor does not simply sum up the signal voltages based on the signal charges of the first and the second photodiodes PD1 and PD2, but may perform weighting summing in the ratio of 2:1.

As described above, in the present embodiment, a photodiode of high sensitivity and a photodiode of low sensitivity are provided in each unit cell. In addition, when the signal charge quantities are small, both the signals of the high-sensitive and low-sensitive photodiodes are used. In this case, it is desirable to sum up the signal charges in the unit cell before reading. When the signal charge quantities are large, only the signal of the low-sensitive photodiode is read out. As described above, two operation modes are used for different situations.

In the first embodiment, since a photodiode of high sensitivity and a photodiode of low sensitivity are provided in each unit cell, it can be considered that the relation of the following expression (1) is established. In the expression, the light sensitivity and the saturation level of a common unit cell including only one photodiode are denoted by SENS and VSAT, respectively, the light sensitivity and the saturation level of the first photodiode PD1 having high sensitivity are denoted by SENS1 and VSAT1, respectively, and the light sensitivity and the saturation level of the second photodiode PD2 having low sensitivity are denoted by SENS2 and VSAT2, respectively.

SENS−SENS1+SENS2 VSAT−VSAT1+VSAT2 (1

When the high sensitivity mode is switched to the low sensitivity mode by saturation of the first photodiode PD1 having high sensitivity, the signal charge quantity obtained by each unit cell is reduced, and the S/N ratio is decreased. The light quantity by which the first photodiode PD1 of high sensitivity is saturated is indicated by “VSAT1/SENS1”. The signal charge quantity of the second photodiode PD2 of low sensitivity with the light quantity “VSAT1/SENS1” is indicated by “VSAT1×SENS2/SENS1”. Therefore, the decrease rate of the signal charge quantity with the light quantity is provided by the following expression (2).

(VSAT1×SENS2/SENS1)/(VSAT1×SENS/SENS1)=SENS2/SENS (2)

Since a signal decrease in switching the modes from the high sensitivity mode to the low sensitivity mode should be avoided, it is considered appropriate to set the value of “SENS2/SENS” to a percentage from 10% to 50%. In the present embodiment, the value of “SENS2/SENS” is set to “¼=25%”.

On the other hand, the effect E_{dyn} of increasing the dynamic range is calculated by the following expression (3), by obtaining the ratio of the maximum incident light quantity VSAT2/SENS2 to the maximum incident light quantity (dynamic range) VSAT/SENS of a common unit cell.

E_{dyn}=(VSAT2/VSAT)×(SENS/SENS2) (3)

As is clear from the expression (3), it is desirable to set the value of “VSAT2/VSAT” as large as possible. This means that the saturation levels of the high-sensitive and low-sensitive photodiodes should be almost the same, or the saturation level of the low-sensitive photodiode should be higher than that of the high-sensitive photodiode. This is indicated by the following expression (4).

VSAT1/SENS1<VSAT2/SENS2 (4)

When the expression (4) is satisfied, the dynamic range can be increased.

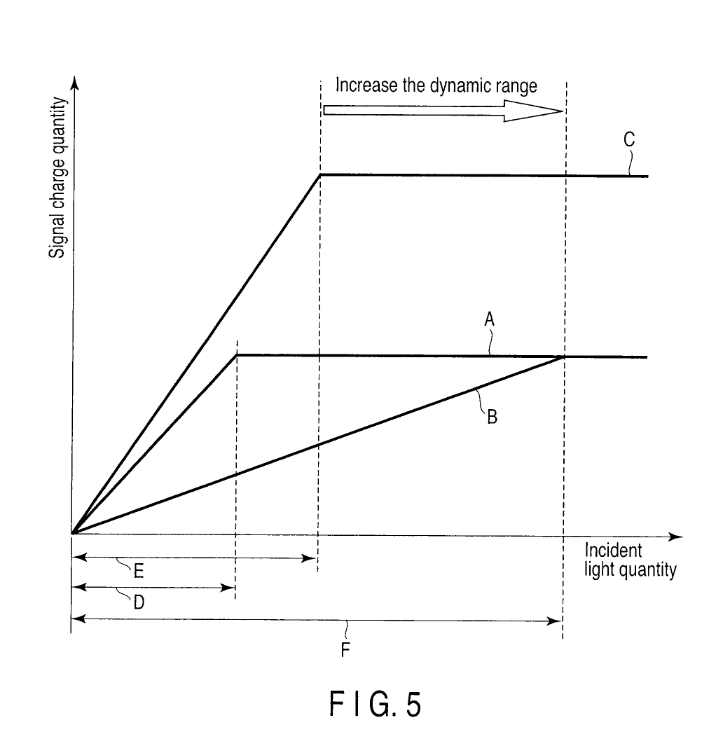

FIG. 5 is a characteristic diagram for explaining the effect of increasing the dynamic range in the CMOS image sensor of the present embodiment. In FIG. 5, the horizontal axis indicates an incident light quantity, and the vertical axis indicates a signal charge quantity generated in the photodiodes. In FIG. 5, A denotes the characteristic of incident light quantity versus signal charge quantity of the high-sensitive photodiode PD1, B denotes the characteristic of incident light quantity versus signal charge quantity of the low-sensitive photodiode PD2, and C denotes the characteristic of incident light quantity versus signal charge quantity of the photodiode in a usual cell unit which has one photodiode. D denotes the dynamic range of the low-sensitive photodiode PD2, E denotes the dynamic range of the photodiode in a usual cell unit, and F denotes the dynamic range of the high-sensitive photodiode PD1.

In the present embodiment, the light sensitivity of the high-sensitive photodiode PD1 is set to ¾ the light sensitivity of the photodiode in the usual cell unit, and the light sensitivity of the low-sensitive photodiode PD2 is set to ¼ the light sensitivity the photodiode in the usual cell unit. In addition, the saturation levels of the photodiodes PD1 and PD2 are set to ½ the saturation level of the photodiode in the usual cell unit.

As is clear from FIG. 5, since the light sensitivity of the high-sensitive photodiode PD1 is set to ¾ the light sensitivity of the photodiode in the usual cell unit and the light sensitivity of the low-sensitive photodiode PD2 is set to ¼ the light sensitivity of the photodiode in the usual cell unit, the signal charge quantity in the high sensitivity mode in which the outputs of the high-sensitive and the low-sensitive photodiodes are summed up is equal to the signal charge quantity of the usual cell unit.

On the other hand, since the saturation level of the low-sensitive photodiode PD2 is ½ that of the photodiode in the usual cell unit and the light sensitivity of the low-sensitive photodiode PD2 is ¼ that of the photodiode in the usual cell unit, consequently the range in which the low-sensitive photodiode PD2 operates without saturation (F in FIG. 5) is twice as wide as the dynamic range of the photodiode in the usual cell unit. Specifically, the dynamic range in the low sensitivity mode in which the output of the low-sensitive photodiode PD2 is used is twice as wide as the dynamic range of usual cell unit (E in FIG. 5).

As described above, according to the CMOS image sensor of the first embodiment, it is possible to obtain the effect that the dynamic range can be increased by using the low sensitivity mode, and deterioration in light sensitivity in the case of small light quantity (the case where it is dark) can be reduced by using the high sensitivity mode. Specifically, the tradeoff relation between the light sensitivity and the signal charge dealing quantity is overcome, making it possible to increase the signal charge dealing quantity while noise in dark situations is suppressed.

In addition, since the present embodiment achieves an increase in the dynamic range of the CMOS image sensor, it is possible to easily design a high-speed sensor with high frame rate, by using the advantages of CMOS image sensors, such as pixel skipping operation.

In the CMOS image sensor of the first embodiment, each of the first photodiode PD1 and the second photodiode PD2 has a commonly used RGB Bayer arrangement. Therefore, output signals in both the high sensitivity mode and the low sensitivity mode are compliant with the RGB Bayer arrangement. Therefore, conventional processing can be used for color signal processing, such as de-mosaic processing.

In addition, in the CMOS image sensor of the first embodiment, the first and the second photodiodes PD1 and PD2 are arranged in a check pattern. Therefore, as illustrated in FIG. 2A, the floating diffusion FD is disposed between the first and the second photodiodes PD1 and PD2, and the amplifying transistor AMP and the reset transistor RST are disposed in the remaining space. Thereby, the layout of components in each unit cell can be easily performed.

### Second Embodiment

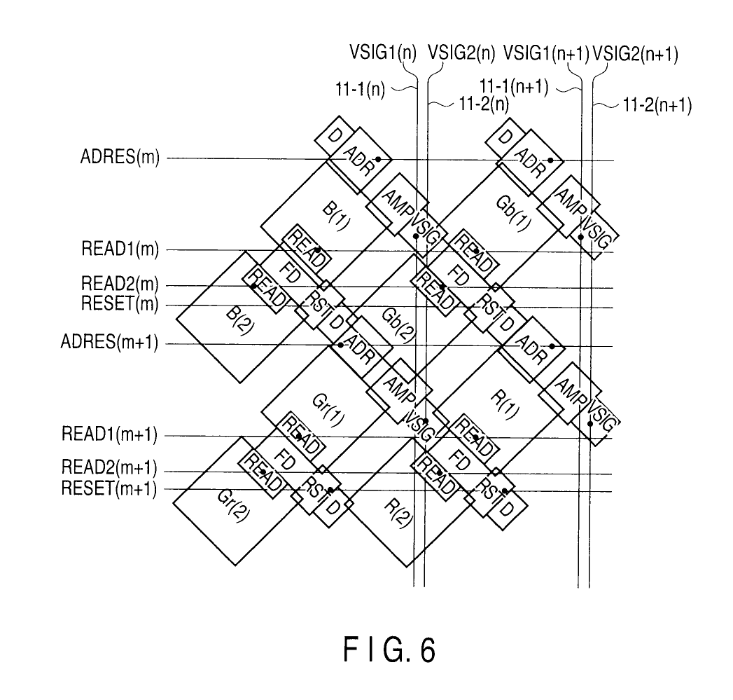

FIG. 6 is a pattern plan view schematically illustrating a part of a layout image of device formation regions and gates of an imaging region of a CMOS image sensor according to a second embodiment. FIG. 6 illustrates signal lines which transmit pixel driving signals ADRES(m), RESET(m), READ1(m), and READ2(m) of row m, signal lines which transmit pixel driving signals ADRES(m+1), RESET(m+1), READ1(m+1), and READ2(m+1) of row (m+1), two vertical signal lines 11-1(n) and 11-2(n) of column n, and two vertical signal lines 11-1(n+1) and 11-2(n+1) of column (n+1). Specifically, in the second embodiment, each unit cell column is provided with two vertical signal lines, and signals amplified by the amplifying transistors of alternating unit cell rows of the unit cell column are transmitted to the two vertical signal lines. The layout of color filters and microlenses is the same as the layout in the first embodiment illustrated in FIG. 2B.

In the CMOS image sensor of the second embodiment, like the first embodiment, a photodiode of high sensitivity and a photodiode of low sensitivity are arranged in each unit cell, a microlens having a large area is disposed on the photodiode of high sensitivity, and a microlens having a small area is disposed on the photodiode of low sensitivity. In this embodiment, to enhance the frame rate (the number of pictures which can be output for 1 second), two vertical signal lines are arranged for each column of the imaging region. Outputs of the amplifying transistors of alternating rows of the column are connected to one of the two vertical signal lines, and outputs of the amplifying transistors of the other alternating rows of the column are connected to the other of the two vertical signal lines. The second embodiment produces the same effect as that of the first embodiment. In addition, signals of unit cells of two rows can be simultaneously read out, and the frame rate can be improved.

### Third Embodiment

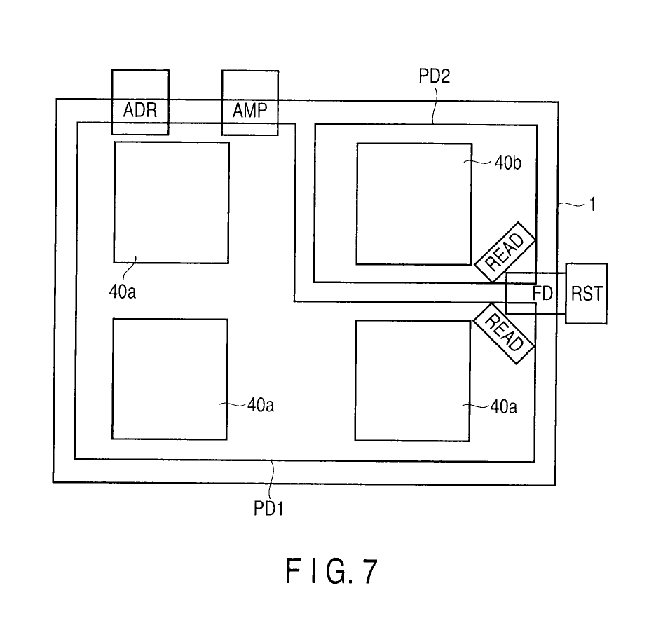

FIG. 7 is a pattern plan view of one of unit cells in an imaging region of a CMOS image sensor according to a third embodiment, schematically illustrating a layout image of device formation regions, gates, color filters and microlenses of the CMOS image sensor.

The third embodiment is the same as the first embodiment, in that a first photodiode PD1 having high sensitivity and a second photodiode PD2 having low sensitivity are arranged in a unit cell 1, color filters and microlenses are arranged in an RGB Bayer arrangement, and in the circuit configuration of the unit cell 1 and the reading method. The high-sensitive photodiode PD1 has an almost L-shaped plane, as illustrated in FIG. 7. The third embodiment is different from the first embodiment, in that four microlenses 40a and 40b having the same size are arranged in the unit cell 1. Three microlenses 40a are arranged apart on the high-sensitive photodiode PD1, and one microlens 40b is disposed on the low-sensitive photodiode PD2. Specifically, a microlens which collects light onto the first photodiode PD1 is formed of the three microlenses 40a, and the sum of the plane area of the three microlenses 40a is larger than the plane area of the microlens 40b which collects light onto the second photodiode PD2. The microlens which collects light onto the first photodiode PD1 may be formed of four or more microlenses.

According to the third embodiment, since the microlenses arranged in each unit cell have the same size, there is the effect that the manufacturing method thereof is simplified compared to the case where each unit cell has two types of microlenses having different sizes, as in the first embodiment.

### Fourth Embodiment

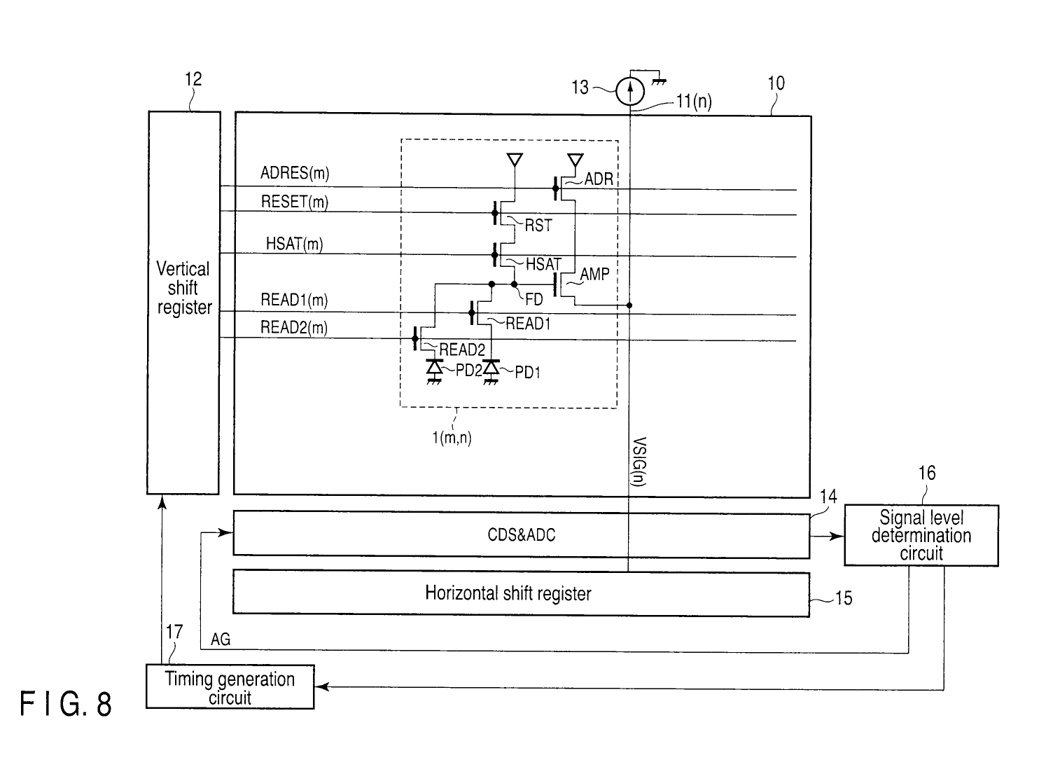

FIG. 8 is a block diagram schematically illustrating a CMOS image sensor according to a fourth embodiment. The fourth embodiment is the same as the first embodiment, in that a plurality of unit cells 1 are arranged in rows and columns in an imaging region 10 of the CMOS image sensor, a high-sensitive photodiode PD1 and a low-sensitive photodiode PD2 are arranged in each unit cell 1, color filters are arranged in an RGB Bayer arrangement, and the CMOS image sensor is provided with a vertical shifter register 12, current sources 13, a CDS and ADC 14, a horizontal shift register 15, a signal level determination circuit 16, and a timing generation circuit 17. However, the fourth embodiment is different from the first embodiment in the circuit configuration of each unit cell and the reading method.

Specifically, the unit cell 1(m, n) is different from that of the first embodiment in that a capacitance adjusting (adding) transistor HSAT is inserted between a source of a reset transistor RST and a floating diffusion FD. In addition, the vertical shift register 12 supplies a pixel driving signal HSAT(m) to control the transistor HSAT, as well as pixel driving signals such as ADRES(m), RESET(m), READ1(m), and READ2(m) to each row of the imaging region.

When a signal charge quantity read by a first reading transistor READ1 or a second reading transistor READ2 is large, a high voltage is applied to a gate electrode of the capacitance adjusting transistor HSAT to control the transistor HSAT to an ON state. Thereby, the transistor HSAT is used as a MOS capacitor, and a capacitance thereof is added to the capacitance of the floating diffusion FD. Thereby, the dynamic range of the floating diffusion FD can be increased. When a signal charge quantity read by the first or the second reading transistor READ1 or READ2 is small, the transistor HSAT is controlled to an OFF state.

According to the fourth embodiment, the dynamic range of each unit cell can be further increased in comparison with the first embodiment.

In the same manner as the first embodiment, the fourth embodiment is not limited to the case where signal charges are summed up in the floating diffusion FD in the high sensitivity mode. It is possible to transmit signal charges of the first and the second photodiodes PD1 and PD2 to the floating diffusion FD independently of each other through the first and the second reading transistors READ1 and READ2, respectively, amplify the potentials of the floating diffusion FD by the amplifying transistor AMP to output voltage signals independently of each other, and sum up the voltage signals in a signal processing circuit outside the CMOS sensor.

In addition, in the same manner as the second embodiment, two vertical signal lines may be arranged for each column of the imaging region, and outputs of the amplifying transistors of alternating rows of each column may be connected to the vertical signal lines.

In addition, in the same manner as the third embodiment, it is possible to arrange four microlenses having the same size in each unit cell, arrange three microlenses apart on the high-sensitive photodiode PD1, and dispose one microlens on the low-sensitive photodiode PD2.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
an imaging region including a plurality of unit cells arranged in rows and columns, each of the unit cells including a first photodiode which performs photoelectric conversion for incident light and stores a converted signal charge, a first reading transistor which is connected to the first photodiode and reads out the signal charge from the first photodiode, a second photodiode which performs photoelectric conversion for incident light, stores a converted signal charge and has a light sensitivity lower than a light sensitivity of the first photodiode, a second reading transistor which is connected to the second photodiode and reads out the signal charge from the second photodiode, a floating diffusion which is connected to the first reading transistor and the second reading transistor, and stores the signal charges of the first and the second photodiodes, a reset transistor which is connected to the floating diffusion and resets a potential of the floating diffusion, and an amplifying transistor which is connected to the floating diffusion and amplifies the potential of the floating diffusion; and
a control circuit which has a first operation mode and a second operation mode, configured to perform control, in the first operation mode, of transmitting the signal charges of the first and the second photodiodes to the floating diffusion through the first and the second reading transistors, respectively, summing up the signal charges, amplifying the potential of the floating diffusion by the amplifying transistor and outputting a signal, and configured to perform control, in the second operation mode, of transmitting the signal charge of the second photodiode to the floating diffusion through the second reading transistor, amplifying the potential of the floating diffusion by the amplifying transistor and outputting a signal.

2. The device according to claim 1, wherein
the control circuit has a vertical shift register which controls the first and the second reading transistors and the reset transistor for each unit cell column.

3. The device according to claim 1, wherein
each of the unit cells further includes an address transistor which is connected to the amplifying transistor in series.

4. The device according to claim 1, wherein
each of the unit cells further includes a capacitance adding transistor which is connected between the reset transistor and the floating diffusion.

5. The device according to claim 1, further comprising
a plurality of vertical signal lines, to which signals amplified by the amplifying transistors of respective unit cell columns are transmitted.

6. The device according to claim 1, further comprising
a plurality of vertical signal lines including pairs of two vertical signal lines, the pairs being provided for respective unit cell columns, and the two vertical signals lines of each of the pairs receiving signals amplified by the amplifying transistors of respective alternating rows of the unit cell column.

7. The device according to claim 1, wherein
the light sensitivities and saturation levels of the first and the second photodiodes are set to satisfy an expression “VSAT1/SENS1<VSAT2/SENS2”, in which SENS1 denotes the light sensitivity of the first photodiode, VSAT1 denotes the saturation level of the first photodiode, SENS2 denotes the light sensitivity of the second photodiode, and VSAT2 denotes the saturation level of the second photodiode.

8. The device according to claim 1, further comprising:
a first microlens which collects light and applies the light to the first photodiode; and
a second microlens which collects light and applies the light to the second photodiode.

9. The device according to claim 8, wherein
a plane area of the first microlens is larger than a plane area of the second microlens.

10. The device according to claim 1, further comprising:
a plurality of first microlenses which collect light and apply the light to the first photodiode; and
a second microlens which collects light and applies the light to the second photodiode.

11. The device according to claim 10, wherein
the sum of plane areas of the first microlenses is larger than a plane area of the second microlens.

12. A solid-state imaging device comprising:
an imaging region including a plurality of unit cells arranged in rows and columns, each of the unit cells including a first photodiode which performs photoelectric conversion for incident light and stores a converted signal charge, a first reading transistor which is connected to the first photodiode and reads out the signal charge from the first photodiode, a second photodiode which performs photoelectric conversion for incident light, stores a converted signal charge and has a light sensitivity lower than light sensitivity of the first photodiode, a second reading transistor which is connected to the second photodiode and reads out the signal charge from the second photodiode, a floating diffusion which is connected to the first reading transistor and the second reading transistor, and stores the signal charges of the first and the second photodiodes, a reset transistor which is connected to the floating diffusion and resets a potential of the floating diffusion, and an amplifying transistor which is connected to the floating diffusion and amplifies the potential of the floating diffusion; and
a control circuit which has a first operation mode and a second operation mode, configured to perform control, in the first operation mode, of transmitting the signal charges of the first and the second photodiodes to the floating diffusion independently of each other through the first and the second reading transistors, respectively, amplifying the potentials of the floating diffusion by the amplifying transistor and outputting signals independently of each other, and configured to perform control, in the second operation mode, of transmitting the signal charge of the second photodiode to the floating diffusion through the second reading transistor, amplifying the potential of the floating diffusion by the amplifying transistor and outputting a signal.

13. The device according to claim 12, wherein
the control circuit has a vertical shift register which controls the first and the second reading transistors and the reset transistor for each unit cell column.

14. The device according to claim 12, wherein
each of the unit cells further includes an address transistor which is connected to the amplifying transistor in series.

15. The device according to claim 12, further comprising
a plurality of vertical signal lines, to which signals amplified by the amplifying transistors of respective unit cell columns are transmitted.

16. The device according to claim 12, further comprising
a plurality of vertical signal lines including pairs of two vertical signal lines, the pairs being provided for respective unit cell columns, and the two vertical signals lines of each of the pairs receiving signals amplified by the amplifying transistors of respective alternating rows of the unit cell column.

17. The device according to claim 12, wherein
the light sensitivities and saturation levels of the first and the second photodiodes are set to satisfy an expression “VSAT1/SENS1<VSAT2/SENS2”, in which SENS1 denotes the light sensitivity of the first photodiode, VSAT1 denotes the saturation level of the first photodiode, SENS2 denotes the light sensitivity of the second photodiode, and VSAT2 denotes the saturation level of the second photodiode.

18. The device according to claim 12, further comprising:
a first microlens which collects light and applies the light to the first photodiode; and
a second microlens which collects light and applies the light to the second photodiode.

19. The device according to claim 18, wherein
a plane area of the first microlens is larger than a plane area of the second microlens.

20. The device according to claim 12, further comprising:
a plurality of first microlenses which collect light and apply the light to the first photodiode; and
a second microlens which collects light and applies the light to the second photodiode.
